(19) United States
(12) Patent Application Publication
(10) Pub. No.: US 2024/0418107 A1
(43) Pub. Date: Dec. 19, 2024

(54) ENGINE, A METHOD OF OPERATING AN ENGINE, AND A CONTROLLER

(71) Applicant: CUMMINS INC., Columbus, IN (US)

(72) Inventor: Scott Robert Bardakjy, Columbus, IN (US)

(73) Assignee: CUMMINS INC., Columbus, IN (US)

(21) Appl. No.: 18/210,351

(22) Filed: Jun. 15, 2023

(51) Int. Cl. F01L 13/00; F01L 1/18; F01L 13/06; F02D 13/02; F02D 13/04; F02D 13/06

(52) U.S. Cl. CPC F01L 13/0005; F01L 1/18; F01L 13/06; F02D 13/0249; F02D 13/04; F02D 13/06; F01L 2013/001; F01L 2305/02

(57) ABSTRACT

An engine system including an engine block. The engine block including a plurality of cylinders defining a plurality of combustion chambers each comprising one of a cylinder head and a piston. Each of the plurality of cylinder heads includes an exhaust valve and an intake valve. The engine system further includes a first control valve, a second control valve, rocker lever, and an auxiliary rocker lever. The first control valve is coupled to the camshaft and configured to activate the rocker lever. The second control valve is coupled to the camshaft and configured to activate the auxiliary rocker lever. The rocker leaver is configured to actuate the at least one exhaust valve to allow exhaust gas to flow out of at least one of the plurality of cylinders. The auxiliary rocker lever is configured to actuate at least one of the plurality of exhaust valves to allow exhaust to flow into the cylinder.

### STATEMENT OF GOVERNMENT SUPPORT

This invention was made with Government support under DE-EE0009460 awarded by DOE. The Government has certain rights in this invention.

### TECHNICAL FIELD

The present disclosure relates generally to an internal combustion engine with cylinder deactivation.

### BACKGROUND

An internal combustion engine performs cylinder deactivation to increase fuel efficiency. Cylinder deactivation involves closing the intake valves and the exhaust valves of a cylinder and signaling to the fuel injector to turn off injection into the cylinder. By closing the intake valves and exhaust valves, and stopping the injection of fuel and sparking, combustion within the cylinder will not occur.

### SUMMARY

One embodiment relates to an engine system including an engine. The engine includes an engine block. The engine block includes a plurality of cylinders defining a plurality of combustion chambers and at least one cylinder head. The plurality of combustion chambers each having one of a plurality of pistons positioned therein. The engine system further includes a crankshaft coupled to each of the plurality of pistons. The crankshaft is configured to move each of the plurality of pistons from a first piston position to a second piston position. The engine system includes a camshaft coupled to the crankshaft. The engine system includes a rocker lever coupled to the camshaft, the rocker lever configured to open and close a first exhaust valve positioned on the at least one cylinder head. The engine system includes an auxiliary rocker lever coupled to the camshaft. The auxiliary rocker lever is configured to open and close a second exhaust valve positioned on the at least one cylinder head. The engine system further includes a first control valve coupled to the engine. The first control valve is configured to deactivate the rocker lever, and a controller is communicatively coupled to the first control valve. The controller is configured to selectively actuate at least the first control valve.

Another embodiment relates to a method of operating an engine according to a combustion cycle. The method includes receiving a first signal at a first control valve. The method further includes, in response to the received first signal, deactivating, by the first control valve, a rocker lever, thereby deactivating a cylinder by closing a first exhaust valve, a second exhaust valve, and an intake valve, and activating, by the first control valve, an auxiliary rocker lever to open the second exhaust valve allowing an amount of exhaust to flow into the cylinder during a rebreathing lift. The method further includes receiving a second signal at the first control valve. The method still further includes, in response to the received second signal, deactivating, by the first control valve, the auxiliary rocker lever, and re-activating, by the first control valve, the rocker lever, thereby re-activating the first cylinder by opening at least one of the first exhaust valve, the second exhaust valve, or the intake valve.

Another embodiment relates to a controller for an engine. The controller is configured to send a first signal to a first control valve for an engine. The first signal instructs the first control valve to de-activate a rocker lever. The first signal further instructs the first control valve to activate an auxiliary rocker lever to move from a first auxiliary position to a second auxiliary position opening and closing at least one exhaust valve during a rebreathing lift. The controller is further configured to send a second signal to the first control valve for the engine. The second signal instructs the first control valve to deactivate the auxiliary rocker lever. The second signal further instructs the first control valve to activate the rocker lever to move from a first position to a second position opening and closing at least one exhaust valve.

### BRIEF DESCRIPTION OF THE DRAWINGS

FIG. 1 is a depiction of an example engine system including an internal combustion engine;

FIG. 2 depicts a portion of the engine system of FIG. 1;

FIG. 3A shows a piston-cylinder arrangement of the engine system of FIG. 1 during a compression stroke;

FIG. 3B shows the piston-cylinder arrangement of FIG. 3A during the transition between the compression stroke and a power stroke;

FIG. 3C shows the piston-cylinder arrangement of FIG. 3A during the power stroke;

FIG. 3D shows the piston-cylinder arrangement of FIG. 3A during a transition between the power stroke and an exhaust stroke;

FIG. 3E shows the piston-cylinder arrangement of FIG. 3A during the exhaust stroke;

FIG. 3F shows the piston-cylinder arrangement of FIG. 3A during a transition between the exhaust stroke and the intake stroke;

FIG. 3G shows the piston-cylinder arrangement of FIG. 3A during a first portion of the intake stroke;

FIG. 3H shows the piston-cylinder arrangement of FIG. 3A during a second portion of the intake stroke;

FIG. 4 is a graph depicting the lift verses the crank angle during a combustion cycle illustrating a rebreathing stroke in the combustion cycle;

FIG. 5 is a graph depicting the lift verses the crank angle during a combustion cycle illustrating the rebreathing stroke, a deactivation period, and re-activation period of the combustion cycle;

FIG. 6 is a graph depicting the lift verses the crank angle during a combustion cycle illustrating the rebreathing stroke, the deactivation period, and the re-activation period of the combustion cycle according to another embodiment;

FIG. 7 is a graph depicting the lift verses the crank angle during a combustion cycle illustrating the rebreathing stroke, the deactivation period, and the re-activation period according of the combustion cycle to another embodiment;

FIG. 8 is a graph depicting the lift verses the crank angle during a combustion cycle illustrating the combustion cycle including the rebreathing stroke, the deactivation period, and the re-activation period of the combustion cycle according to yet another embodiment;

FIG. 9 is a flowchart depicting a method of operating the engine system by a controller according to one embodiment; and

FIG. 10 is a flowchart depicting a method of operating the engine system by a controller according to another embodiment.

### DETAILED DESCRIPTION OF EMBODIMENTS

Following below are more detailed descriptions of various concepts related to, and implementations of, systems, methods, and apparatuses, for cylinder deactivation, including an auxiliary lift valve, in an internal combustion engine. The various concepts introduced above and discussed in greater detail below may be implemented in any number of ways, as the described concepts are not limited to any particular manner of implementation. Examples of specific implementation and application are provided primarily for illustrative purposes.

### I. Overview of an Internal Combustion Engine

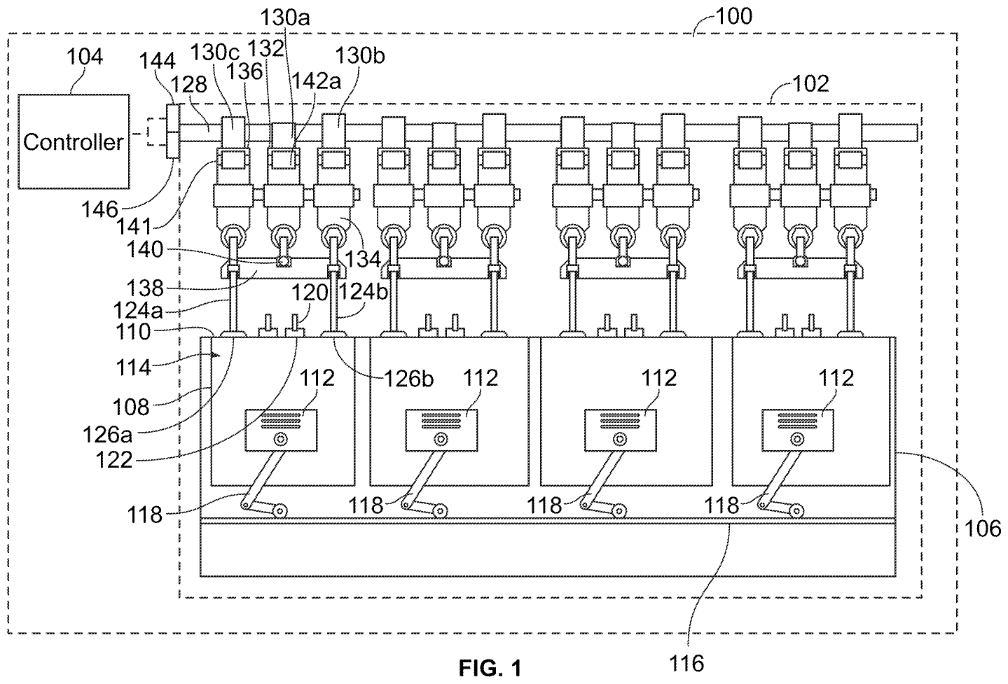

FIG. 1 depicts an engine system 100. The engine system 100 includes an engine 102. The engine 102 is an internal combustion engine. The engine 102 includes an engine block 106. The engine block 106 includes a plurality of cylinders 108 defining a plurality of combustion chambers 114 and at least one cylinder head 110. The plurality of combustion chambers 114 each have one of a plurality of pistons 112 positioned therein. The engine system 100 further includes a crankshaft 116 coupled to each of the plurality of pistons 112. The crankshaft 116 is configured to move each of the plurality of pistons 112 from a first piston position to a second piston position. The engine system 100 includes a camshaft 128 coupled to the crankshaft 116. The engine system 100 includes a rocker lever 132 coupled to the camshaft 128, the rocker lever 132 configured to open and close a first exhaust valve 124a positioned on the at least one cylinder head 110. The engine system 100 includes an auxiliary rocker lever 134 coupled to the camshaft 128. The auxiliary rocker lever 134 is configured to open and close a second exhaust valve 124b positioned on the cylinder head 110 of the plurality of cylinder heads 110. The engine system 100 also includes a first control valve 144 coupled to the engine. The first control valve 144 is configured to deactivate the rocker lever 132.

The engine system 100 further includes a controller 104. The controller 104 is communicably coupled to the engine 102. The controller 104 is configured to control various operations of the engine 102.

The controller 104 is configured to send a first signal to the first control valve 144 for the engine 102. For example, the first control valve 144 can be an oil control valve. The first signal instructs the first control valve 144 to de-activate the rocker lever 132. The controller 104 is further configured to send a second signal to the first control valve 144 for the engine 102. The second signal instructs the first control valve 144 to activate the rocker lever 132 to move from a first position to a second position opening and closing at least one exhaust valve 124.

The engine block 106 is configured to support various components of the engine system 100. The engine block 106 includes the plurality of engine cylinders 108. For example, according to some embodiments, the engine block 106 includes four cylinders 108. In other embodiments, the engine block 106 may include more than eight cylinders 108 or less than six cylinders 108.

The plurality of engine cylinders 108 each comprise one of the plurality of cylinder heads 110 and one of the plurality of pistons 112. The piston 112 is positioned below the cylinder head 110 within the cylinder 108. Each piston 112 is configured to move axially within a respective engine cylinder 108.

Each engine cylinder 108 defines a respective combustion chamber 114. For example, the walls of each engine cylinder 108, cylinder head 110, and piston 112 define the combustion chamber 114, within which combustion of fuel and oxygen occurs. The vertical movement of each piston 112 increases and decreases the size of the associated combustion chamber 114. Each cylinder head 110 is configured to selectively open and close a respective combustion chamber 114.

The crankshaft 116 is coupled to each of the plurality of pistons 112. The crankshaft 116 is positioned in the engine block 106. The crankshaft 116 is configured to move the plurality of pistons from a first piston position to a second piston position and back to the first piston position. For example, the crankshaft 116 rotates at a speed moving each of the plurality of pistons 112 a vertical distance within the plurality of engine cylinders 108. As the plurality of pistons 112 move toward the plurality of cylinder heads 110 within the plurality of engine cylinders 108, the plurality of combustion chambers 114 decrease in size. As the plurality of pistons 112 move toward the bottom of the plurality of engine cylinders 108, the plurality of combustion chambers 114 increase in size.

The engine system 100 includes at least one intake valve 120 positioned in an intake port 122 on at least one of the plurality of cylinder heads 110. For example, the engine system 100 can include two intake valves 120. The intake valve 120 is configured to open the intake port 122 to allow air to flow into the cylinder 108. For example, the intake valve 120 may move toward the piston 112 to open the intake port 122 and allow air to flow into the cylinder during a combustion cycle. During an intake stroke, the intake valve 120 opens to allow air to flow through the intake port 122 and into the cylinder 108. The intake valve 120 is further configured to close to prevent air flow into the cylinder 108. For example, the intake valve 120 may move toward the cylinder head 110 to close the intake port 122 to prevent the flow of air into or out of the cylinder 108. During an exhaust stroke, the intake valve 120 is closed to prevent the flow of air into or out of the cylinder 108 through the intake port 122.

The engine system 100 includes at least one exhaust valve 124a and 124b positioned in at least one exhaust port 126 (e.g., a first exhaust port 126a and a second exhaust port 126b) on at least one of the plurality of cylinder heads 110. In the embodiment depicted in FIG. 1, the engine system 100 includes the first exhaust valve 124a and the second exhaust valve 124b. The first exhaust valve 124a and the second exhaust valve 124b are configured to open and close the exhaust ports 126 to allow the flow of exhaust out of the engine cylinder 108 and into an exhaust after treatment system. For example, after combustion occurs, the first exhaust valve 124a and the second exhaust valve 124b open to allow exhaust to flow out of the cylinder 108. The first exhaust valve 124a and the second exhaust valve 124b close (e.g. during an intake stroke) to prevent air from flowing out of the cylinder 108.

The engine system 100 further includes the camshaft 128 and a gear train (not shown). In other embodiments, the engine system may include a timing chain or a timing belt. The gear train couples the camshaft 128 to the crankshaft 116. The camshaft 128 is configured to rotate at a speed with the crankshaft 116 via the gear train. The camshaft 128 includes a plurality of cam lobes 130. The plurality of cam lobes 130 are spaced along the camshaft 128. As the camshaft 128 rotates, the cam lobes 130 also rotate. The cam lobes 130 may be of varying size, shape, and orientation along the camshaft 128.

According to the embodiment of FIG. 1, the engine system 100, further comprises the rocker lever 132. The rocker lever 132 is configured to selectively actuate at least one of the plurality of exhaust valves 124 to allow exhaust to flow out of the cylinders 108.

The auxiliary rocker lever 134 is configured to move from the first auxiliary rocker position to the second auxiliary rocker position. The first auxiliary rocker position may be vertically higher than the second auxiliary position. For example, when the auxiliary rocker lever 134 is in the first auxiliary position, at least one of the plurality of exhaust valves 124a and 124b may be in a closed position such that no exhaust gas can flow out of the cylinder 108 through at least one of the plurality of exhaust ports 126.

The engine system 100 of FIG. 1 further comprises a brake rocker lever 136. The brake rocker lever 136 is configured to operate exhaust braking.

The engine system 100 of FIG. 1 further comprises a crosshead 138. The crosshead 138 is coupled to the auxiliary rocker lever 134 and the brake rocker lever 136. The crosshead is configured to guide the movement of the at least one exhaust valve 124 (e.g., first exhaust valve 124a and second exhaust valve 124b) while opening and closing the exhaust port 126.

The engine system 100 of FIG. 1 further comprises an E-foot 140. The E-foot 140 is in contact with the crosshead 138 when the rocker lever 132 is activated. The rocker lever 132 cyclically moves the E-foot 140 contacting the crosshead 138. The crosshead 138 is configured to actuate (e.g. open and close) the at least one exhaust valves 124a and 124b. For example, if the engine system 100 includes a first exhaust valves 124a and a second exhaust valve 124b, the crosshead 138 is configured to open both the first exhaust valve 124a and the second exhaust valve 124b at the same time (e.g. simultaneously).

The rocker lever 132 is configured to move from the first rocker position to the second rocker position. For example, the first rocker position may be axially extended beyond the second rocker position. For example, when the rocker lever 132 is in the first rocker position, the E-foot 140 may not be in contact with the crosshead 138. When the rocker lever 132 is in the second position, the E-foot 140 is in contact with the crosshead 138. The crosshead 138 is configured to translate the movement of the rocker lever 132 to the plurality of exhaust valves 124a and 124b. For example, the crosshead 138 may guide the plurality of exhaust valves 124a and 124b along a vertical plane to prevent deviation and damage to the engine system 100.

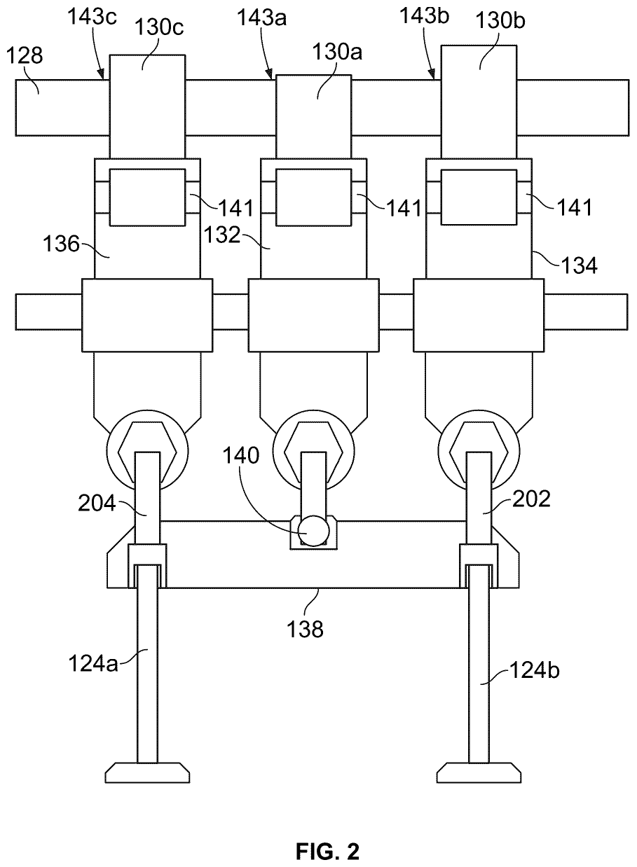

FIG. 2 illustrates a portion of the engine system 100 of FIG. 1. As shown in FIG. 2, the engine system 100 also includes a roller pin 141 and a plurality of cam follower rollers 142. For example, each of the rocker lever 132, the auxiliary rocker lever 134, and the brake rocker lever 136 are coupled to one of the plurality of cam follower rollers 142 (e.g., a first cam follower roller 142a, a second cam follower roller 142b, and a third cam follower roller 142c). Each of the plurality of cam follower rollers 142 are coupled to each of the plurality of cam lobes 130 by the roller pin 141. For example, the plurality of cam follower rollers 142 may be positioned in each of the rocker lever 132, the auxiliary rocker lever 134, and the brake rocker lever 136.

The roller pin 141 can be pressed through the plurality of cam follower rollers 142 within the rocker lever 132, the auxiliary rocker lever 134, and the brake rocker lever 136 to secure the plurality of cam follower rollers 142 to each of the rocker lever 132, the auxiliary rocker lever 134, and the brake rocker lever 136. For example, the rocker lever 132 may be coupled to a first cam follower roller 142a.

The first cam follower roller 142a is coupled to the first cam lobe 130a to form a first cam follower roller joint 143a. The camshaft 128 rotates the first cam lobe 130a, and the first cam follower roller 142a rotates (e.g. turns, spins, wheel-like motion, etc.) and moves the rocker lever 132. The first cam follower roller 142a translates the rotational motion of the first cam lobe 130a to a linear motion of opening and closing the exhaust valves 124a and 124b.

Referring again to FIG. 1, the engine system 100 further includes the first control valve 144. The first control valve 144 is communicatively coupled to the engine 102 and the controller 104. The first control valve 144 may be an oil control valve and may be positioned within the rocker lever 132. In other embodiments, the first control valve may be positioned on a cylinder block 108 adjacent to the rocker lever 132. The rocker lever 132 of the engine system 100 is activated (e.g. turned on, active, moving, engaged etc.) by default. For example, the rocker lever 132 is activated unless selectively deactivated or disengaged. When the rocker lever 132 is activated, the rocker lever 132 translates the motion of the first cam lobe 130a to open and close the at least one exhaust valve 124. The first control valve 144 is configured to deactivate the rocker lever 132. Once the rocker lever 132 is deactivated, the at least one exhaust valve 124 is not opened or closed.

The first control valve 144 is configured to activate the brake rocker lever 136. For example, the brake rocker lever 136 is in a default disengaged or deactivated state. When activated, the brake rocker lever 136 is configured to operate exhaust braking. During exhaust braking, the brake rocker lever 136 opens an exhaust path (e.g., an exhaust valve 124) out of the cylinder 108 only after the engine does work to compress the gases (e.g., exhaust gas) in the cylinder 108.

Also shown in FIG. 1, in some embodiments the engine system can include a second control valve 146. The second control valve 146 is communicatively coupled to the engine 102 and the controller 104. The second control valve 146 may be configured to activate the auxiliary rocker lever 134. For example, the first control valve 144 may be configured to operate the rocker lever 132, while the second control valve 146 is configured to operate at least one of the auxiliary rocker lever 134 and the brake rocker lever 136. For example, the auxiliary rocker lever 134 may be coupled to a second cam follower roller 142b. The second cam follower roller 142b is coupled to the second cam lobe 130b to form a second cam follower roller joint 143b. The camshaft 128 rotates the second cam lobe 130b and the second cam follower roller 142b rotates (e.g. turns, spins, wheel-like motion, etc.) and moves the auxiliary rocker lever 134.

The controller 104 can also send the first signal to the second control valve 146 to control the engine 102. For example, the second control valve 146 can be an oil control valve. The first signal further instructs the second control valve 146 to activate the auxiliary rocker lever 134 to move from a first auxiliary position to a second auxiliary position opening and closing at least one exhaust valve 124 during a rebreathing stroke. The controller 104 is further configured to send a second signal to the second control valve 146 for the engine 102. The second signal instructs the second control valve 146 to deactivate the auxiliary rocker lever 134. In some embodiments, the timing of the controller 104 sending the second signal to the second control valve 146 can occur at the same time as sending the first signal to the first control valve 144. In other embodiments, the controller 104 can send the first signal to the first control valve 144 and the second signal to the second control valve 146 at different timings throughout the cylinder deactivation mode as it can be beneficial for engine performance.

When the auxiliary rocker lever 134 is activated, the auxiliary rocker lever 134 translates the motion of the second cam follower roller joint 143b to open and close the at least one of the first exhaust valve 124a and the second exhaust valve 124b to selectively allow exhaust to flow back into the cylinder 108. By allowing exhaust back into the cylinder 108, the engine system 100 may be more fuel efficient while mitigating noise, vibration, and harshness (NVH) and oil carryover risks. In other embodiments, the auxiliary rocker lever 134 may be configured to translate the motion of the second cam follower roller joint 143b to open and close the intake valve 120.

Referring again to FIG. 2, the engine system 100 further includes an auxiliary valve actuator 202 and a brake valve actuator 204. The auxiliary valve actuator 202 and the brake valve actuator 204 extend through the crosshead 138. The auxiliary valve actuator 202 is coupled to the first exhaust valve 124a. The brake valve actuator 204 is coupled to the second exhaust valve 124b.

When activated by the controller 104, the first control valve 144 or the second control valve 146 activates the auxiliary rocker lever 134. The auxiliary rocker lever 134 is configured to actuate at least one of the first exhaust valve 124a and the second exhaust valve 124b. For example, the controller 104 may deactivate a cylinder 108 such that no fuel is injected into the cylinder 108. Therefore, the auxiliary rocker lever 134 opens at least one of the first exhaust valve 124a and the second exhaust valve 124b to allow an amount (e.g. a small amount) of air and/or exhaust back into the cylinder 108 to mitigate risk associated with noise, vibration, and harshness (NVH) and oil carryover.

### II. Overview of a Combustion Cycle

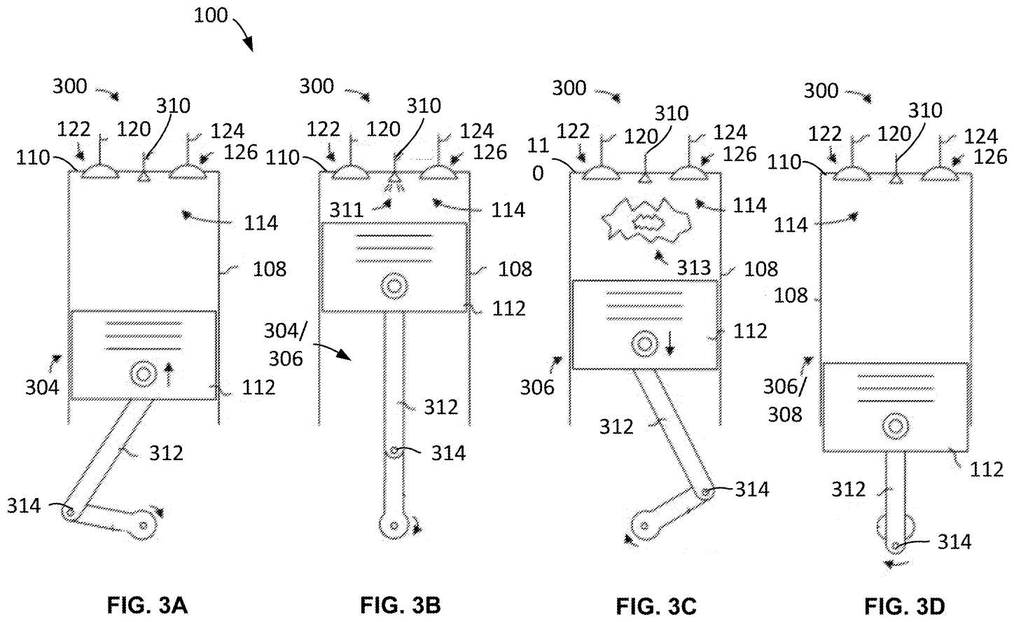

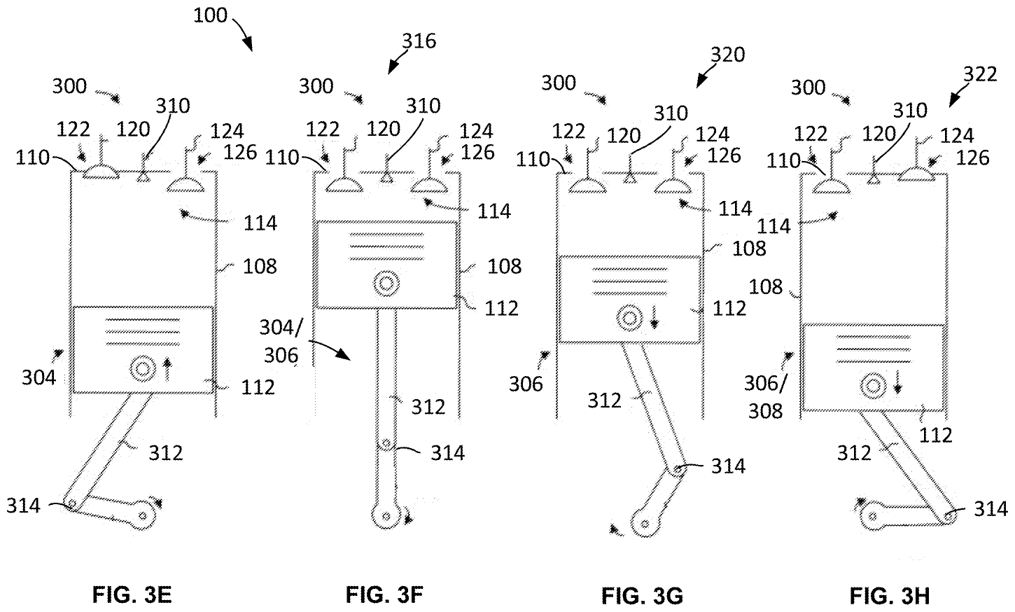

FIGS. 3A-3H depict various stages of a combustion cycle of the engine system 100. The engine system 100 includes the cylinder 108, the intake valve 120 positioned in the intake port 122, the exhaust valve 124 positioned in the exhaust port 126, and the piston 112 positioned within the cylinder 108. As previously discussed, the intake valve 120 and the exhaust valve 124 may be operated via the camshaft 128 rotating to move the rocker lever 132 from a first rocker position to a second rocker position. In other embodiments, the intake valve 120 and the exhaust valve 124 may be electronically controlled by the controller 104.

As variously depicted in FIGS. 3-8, the combustion cycle 300 includes an intake stroke 302, a compression stroke 304, a power stroke 306, and an exhaust stroke 308.

FIGS. 3A-3H illustrate a combustion cycle 300 (e.g. a four-stroke cycle, a rebreathing cycle, etc.) of the engine system 100. As shown in the embodiment of FIGS. 3A-3H, the engine system 100 further comprises a fuel injector 310. The fuel injector 310 is configured to selectively inject fuel into the cylinder 108. In other embodiments, the fuel injector may be positioned such that fuel is injected into the engine system 100 prior to entering the cylinder 108 in order to mix the fuel with intake air before entering the cylinder 108.

As shown in FIGS. 3A-3H, the engine system 100 includes a connecting rod 312. The connecting rod 312 is coupled to the piston 112 and the crankshaft 116. The connecting rod 312 is configured to pivot (e.g., rotate, etc.) with the crankshaft 116 as the piston 112 moves vertically within the cylinder 108. For example, the connecting rod 312 may include a joint 314 wherein the connecting rod 312 pivots at the joint 314 as the piston 112 moves vertically throughout the combustion cycle 300.

FIG. 3A illustrates the position of the piston 112 within the cylinder 108 during the compression stroke 304. During the compression stroke, the piston 112 begins at the bottom of the cylinder 108 (e.g. bottom dead center) (“BDC”). The intake valve 120 and the exhaust valve 124 both begin in a closed position (e.g. the intake port 122 and the exhaust port 126 are sealed). During the compression stroke 304, the piston 112 translates the rotational motion of the crankshaft 116 into linear motion. For example, the piston 112 moves towards the top of the cylinder 108 (e.g. top dead center (“TDC”)). The compression stroke 304 of the combustion cycle 300 is defined by a compression crank angle of the crankshaft 116 of about 180 degrees before the piston 112 to when the piston 112 reaches TDC.

FIG. 3B illustrates the position of the piston 112 within the cylinder 108 during a transition from the compression stroke 304 to the power stroke 306. As the piston 112 moves towards TDC (e.g. towards the cylinder head 110), the combustion chamber 114 decreases in volume compressing the air and/or air-fuel mixture within the cylinder 108. The fuel injector 310 releases an amount of fuel 311 directly into the cylinder 108. In other embodiments, the fuel injector 310 releases an amount of fuel 311 into the engine system 100 upstream of the cylinder 108.

FIG. 3C illustrates the position of the piston 112 within the cylinder 108 during the power stroke 306, the fuel injected 311 into the cylinder 108 mixes with the air and/or air fuel mixture and combusts inside the combustion chamber 114. Combustion 313 within the cylinder 108 drives the piston 112 towards the bottom of the cylinder 108 (e.g., towards BDC). As the piston 112 moves towards BDC, the joint 314 of the connecting rod 312 rotates and the combustion chamber 114 increases in size. The power stroke 306 of the combustion cycle 300 is defined by a crank angle of the crankshaft 116 of about zero degrees to about 180 degrees after the piston 112 reaches top dead center.

FIG. 3D illustrates the position of the piston 112 within the cylinder 108 during a transition between the power stroke 306 to the exhaust stroke 308. As shown in FIG. 3D, the piston 112 reaches the bottom of the cylinder 108 and both the intake valve 120 and the exhaust valve 124 are closed.

FIG. 3E illustrates the position of the piston 112 within the cylinder 108 during the exhaust stroke 308. Once combustion 313 occurs driving the piston 112 to BDC, the exhaust valve 124 may be moved to an open position to allow the exhaust to flow out of the cylinder 108 towards an aftertreatment system (not shown). For example, the exhaust valve 124 may move about 12 mm to 14 mm away from the exhaust port 126. The exhaust stroke 308 is defined by an exhaust crank angle of the crankshaft 116 of about 180 degrees to about 360 degrees after the piston 112 reaches TDC. At this time, the intake valve 120 remains closed to prevent exhaust from flowing out through the intake port 122.

The combustion cycle 300 further includes a transition period 316 as shown in FIG. 3F. The transition period 316 occurs after the exhaust stroke 308 and before the intake stroke 302. During the transition period 316, the intake valve 120 and the exhaust valve 124 are in an open position and the piston 112 is at TDC. For example, the transition period 316 may occur during an overlap range of a plurality of crank angles of the crankshaft 116, such as the crank angles of both the exhaust stroke and the intake stroke.

FIG. 3G illustrates the position of the piston 112 within the cylinder 108 during the intake stroke 302. During a first portion 320 of the intake stroke 302, the intake valve 120 and the exhaust valve 124 are both open (e.g. still in the transition period 316). The exhaust valve 124 begins to close, while the intake valve 120 remains open.

FIG. 3G illustrates the position of the piston 112 within the cylinder 108 during a first portion of the intake stroke 302. As shown in FIG. 3G, during the intake stroke 302, the intake valve remains open, allowing air to flow into the cylinder while the piston 112 is moves toward BDC of the cylinder. During the intake stroke 302, the intake valve 120 may move about 10 mm to 12 mm away from the intake port 122 to allow air to flow into the cylinder 108. The intake stroke 302 is defined by an intake stroke crank angle of the crankshaft 116 of about 360 degrees to about 180 degrees before the piston reaches TDC.

During a second portion 322 of the intake stroke 302, shown in FIG. 3H, the exhaust valve 124 is closed and the piston is positioned at the bottom of the cylinder 108. The intake valve 120 remains in an open position allowing air to flow into the cylinder 108 in preparation for the next compression stroke 304 of the combustion cycle 300.

The combustion cycle 300 as shown in FIGS. 3A-3G depicts one example combustion cycle 300. For example, in other embodiments, the opening and closing of the first exhaust valve 124a and the second exhaust valve 124b may occur between strokes.

### III. Overview of a Rebreathing Lift

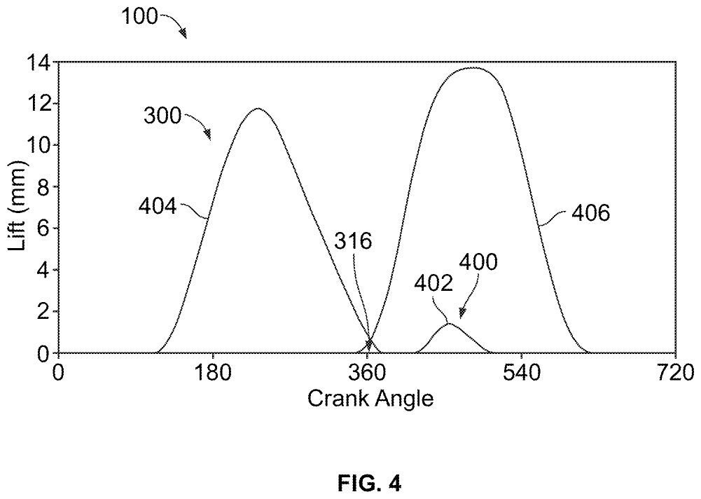

FIGS. 4-8 illustrate various embodiments of the combustion cycle 300 previously described. The combustion cycle 300 further includes a rebreathing lift 400. During the rebreathing lift 400, at least one of the at least one intake valves 120 and the at least one exhaust valve 124 are opened.

The rebreathing lift 400 includes at least one auxiliary valve lift 402. According to some embodiments, the combustion cycle 300 may include a plurality of rebreathing lifts 400 defined by a plurality of auxiliary valve lifts 402. During the auxiliary valve lift 402, the intake valve 120 or the exhaust valve 124 is moved a distance of about less than 2 mm from the intake port 122 or the exhaust port 126 respectively. For example, the auxiliary rocker lever 134 may be configured to perform the auxiliary valve lift 402.

FIG. 4 illustrates a portion of the combustion cycle 300 according to one embodiment. As shown in FIG. 4, the X-axis defines a crank angle in degrees, and the Y-axis defines a distance in millimeters (mm). For example, the Y-axis defines a distance in millimeters that the intake valve 120 is moved away from the intake port 122 and a distance in millimeters that the exhaust valve 124 is moved from the exhaust port 126. At 0 mm on the Y-axis, the intake valve 120 is positioned in the intake port 122 and the exhaust valve 124 is positioned in the exhaust port 126.

As shown in the combustion cycle 300 of FIG. 4, during a crank angle range of about 100 degrees to about 375 degrees, an exhaust lift 404 occurs. During the exhaust lift 404, the exhaust valve 124 moves about 10 mm to 12 mm away from the exhaust port 126. During a crank angle range of about 345 degrees to about 615 degrees, an intake lift 406 occurs. During the intake lift 406, the intake valve 120 moves about 12 mm to 14 mm away from the intake port. During the transition period 316 (e.g. from about 345 degrees to about 375 degrees) both the exhaust valve 124 and the intake valve 120 are in an open position and the piston 112 is near TDC.

According to this embodiment when the cylinder 108 is deactivated, the auxiliary valve lift 402 occurs when the intake lift 406 would occur (e.g., at a crank angle of about 420 to 510, at a crank angle of about 60 to about 150 degrees after the piston 112 reached TDC, etc.). For example, the rocker lever 132 may be deactivated such that the intake valve 120 is not opened, by the rocker lever 132 and the auxiliary rocker lever 134 is activated to perform the auxiliary valve lift 402 during this time. In this embodiment, the rebreathing lift 400 is an exhaust rebreathing lift. During the auxiliary valve lift 402, at least one of the exhaust valves 124 may be opened to allow an amount of exhaust back into the cylinder 108. The auxiliary rocker lever 134 moves the exhaust valve 124 a distance (e.g. a distance less than the distance the exhaust valve 124 is moved during a default combustion cycle). For example, the exhaust valve 124 is moved about less than 2 mm from the exhaust port 126. By moving the exhaust valve 124 a lesser distance, only a small amount of exhaust is able to flow back into the cylinder 108.

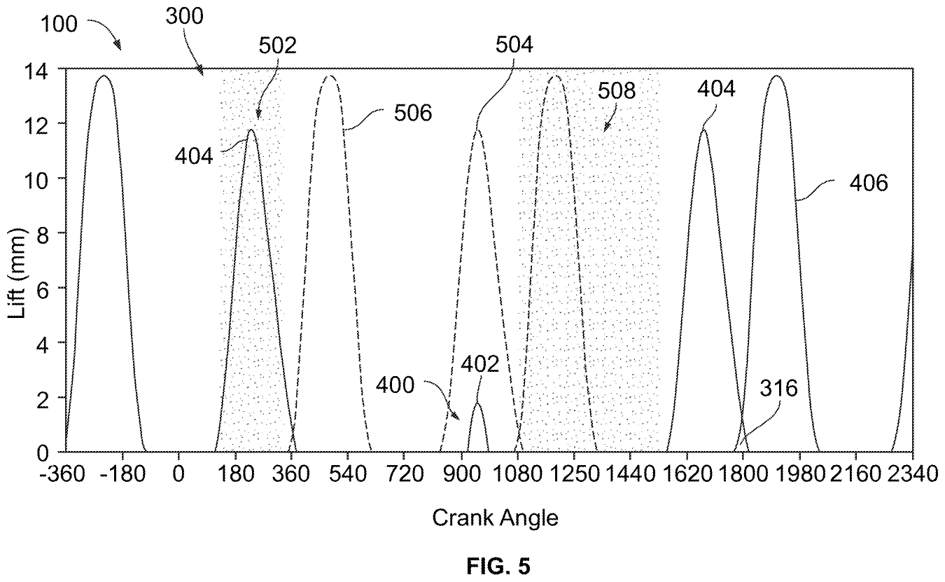

FIG. 5 illustrates the combustion cycle 300 including the auxiliary valve lift 402 according to another embodiment. As shown in FIG. 5, the X-axis defines a crank angle in degrees, and the Y-axis defines a distance in millimeters (mm). The combustion cycle 300 of FIG. 5 may be a low pressure exhaust spring (LPES) system such that cylinder 108 may begin with approximately exhaust manifold pressure and then is reduced to a vacuum as the piston 112 moves down. According to this embodiment, the combustion cycle 300 includes a deactivation window 502. The deactivation window occurs at a crank angle of about 60 degrees to about 150 degrees. During the deactivation window 502, the controller 104 deactivates the cylinder 108 (e.g. shown as deactivated exhaust lift 504 and deactivated intake lift 506). For example, the default combustion cycle 300 is stopped in the deactivated cylinder 108 such that no fuel is injected into the cylinder. The rebreathing lift 400 is an exhaust rebreathing lift. When the intake lift 406 would typically occur (e.g. a crank angle of about 840 degrees to a crank angle of about 1110 degrees), the auxiliary valve lift 402 occurs allowing an amount of exhaust back into the cylinder 108. For example, the auxiliary valve lift 402 is an exhaust default lift.

The combustion cycle 300 further includes a re-activation window 508. The reactivation window occurs at a crank angle of about 1080 degrees to about 1530 degrees. During the re-activation window 508, the controller 104 is configured to reactivate the cylinder 108 such that the cylinder 108 may return to the default combustion cycle 300. For example, the reactivated cylinder 108 may receive an injection of fuel and follow the combustion cycle 300 previously described. For example, the combustion cycle 300 of FIG. 5 first reactivates the exhaust lift 404. According to the embodiment of FIG. 5, the re-activation window 508 may be longer than the deactivation window 502. For example, the re-activation window 508 may be about twice as long as the deactivation window 502. The combustion cycle 300 of FIG. 5 enables a default exhaust event and a default overlap event to occur after a cylinder 108 is re-activated which means a longer re-activation window occurs, allowing for more variation in the performance of the engine system 100 to occur and still have sufficient time to reactivate. Further, the combustion cycle 300 of FIG. 5 may include a plurality of auxiliary valve lifts 402.

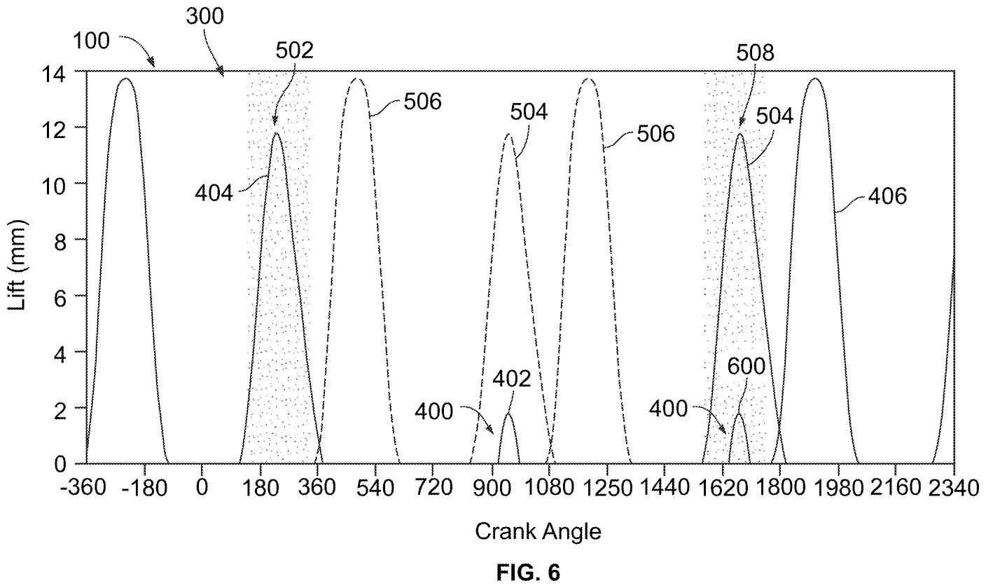

FIG. 6 illustrates the combustion cycle 300 including the auxiliary valve lift 402 according to another embodiment. As shown in FIG. 6, the X-axis defines a crank angle in degrees, and the Y-axis defines a distance in millimeters (mm). The combustion cycle 300 of FIG. 6 may be also be an LPES system. According to this embodiment, the combustion cycle 300 further includes a second auxiliary valve lift 600. The first auxiliary valve lift 402 occurs when the exhaust stroke would typically occur (e.g. deactivated exhaust lifts 504) (e.g. a crank angle of about 840 degrees to a crank angle of about 1110 degrees). The first auxiliary valve lift 402 is an exhaust rebreathing lift. The second auxiliary valve lift 600 occurs at a crank angle of about 1540 degrees to about 1710 degrees. The second auxiliary lift 600, similar to the first auxiliary valve lift 402 is configured to open at least one exhaust valve 124 to allow a second amount of exhaust back into the cylinder 108. During the first auxiliary valve lift 402 and the second auxiliary valve lift 600, the exhaust valve 124 is moved about less than 2 mm away from the exhaust port 126 to allow exhaust to flow back into the cylinder 108. The embodiment of FIG. 6 may include more than two auxiliary valve lifts. For example, a plurality auxiliary valve lifts may occur before reactivation of the cylinder 108.

In the combustion cycle 300 of FIG. 6, after deactivation of the cylinder 108, the intake stroke 406 is bypassed. When the cylinder 108 is reactivated, the combustion cycle 300 resumes with the intake lift 406. According to this embodiment, the re-activation window 508 is about the same duration as the deactivation window 502. The embodiment of FIG. 6 may allow low variations in the engine's brake thermal efficiency (BTE).

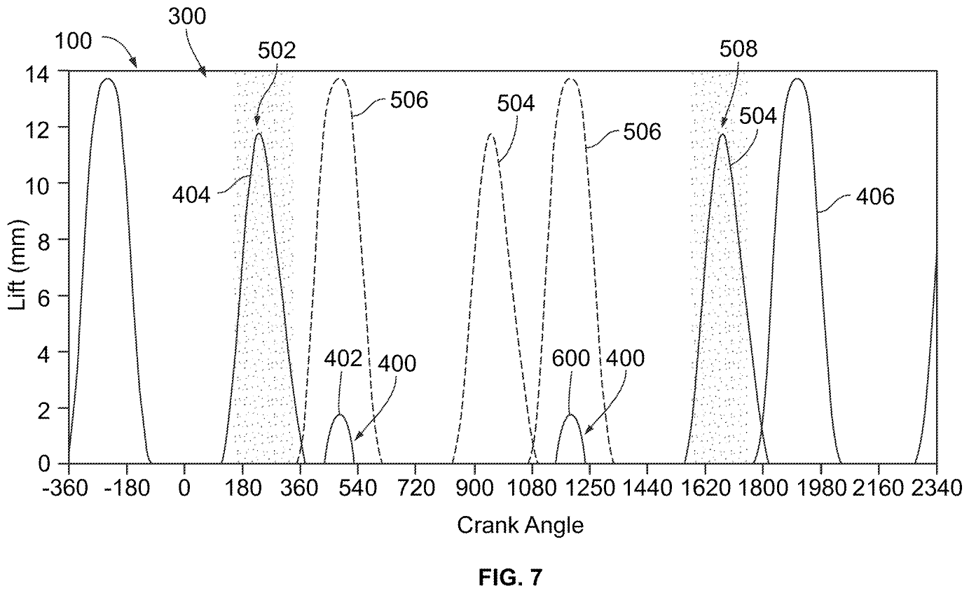

FIG. 7 illustrates the combustion cycle 300 including the first auxiliary valve lift 402 and the second auxiliary valve lift 600 according to another embodiment. The first auxiliary valve lift 402 and the second auxiliary valve lift 600 are intake rebreathing lifts. As shown in FIG. 7, the X-axis defines a crank angle in degrees, and the Y-axis defines a distance in millimeters (mm). After deactivating the cylinder 108, the first auxiliary valve lift 402 occurs when the first intake lift of the default combustion cycle 300 occurs (e.g. deactivated intake lift 506). The first auxiliary valve lift 402 occurs at a crank angle of about 420 degrees to about 540 degrees. The rebreathing lift as shown in FIG. 7 is an intake rebreathing lift. The first auxiliary valve lift 402 occurs immediately after the deactivation window, therefore no deep vacuum is created within the cylinder 108.

The second auxiliary valve lift 600 occurs when the second intake lift 406 occurs. For example, the second auxiliary valve lift 600 may also be an intake rebreathing lift. The second auxiliary valve lift 600 occurs at a crank angle of about 1140 degrees to about 1260 degrees. According to this embodiment, the re-activation window 508 may be the same duration as the deactivation window 502. Further, the combustion cycle 300 of FIG. 7 reactivates the intake lift 406 first when returning to a default combustion cycle 300.

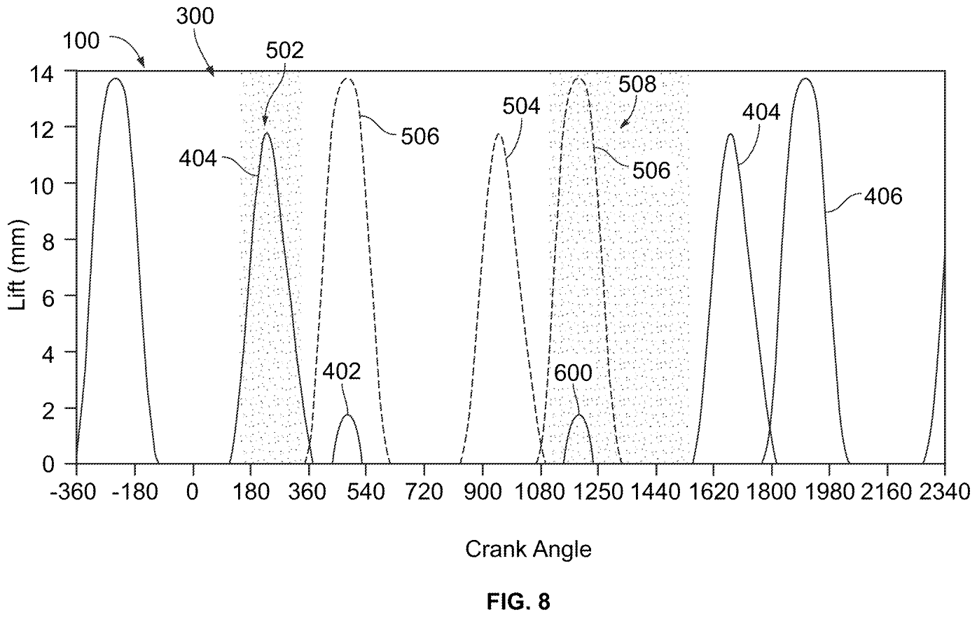

FIG. 8 illustrates the combustion cycle 300 including the first auxiliary valve lift 402 and the second auxiliary valve lift 600 according to yet another embodiment. The first auxiliary valve lift 402 and the second auxiliary valve lift 600 are intake default lifts. As shown in FIG. 8, the X-axis defines a crank angle in degrees, and the Y-axis defines a distance in millimeters (mm). In this embodiment, the first auxiliary valve lift 402 occurs when the first intake lift of the default combustion cycle 300 occurs (e.g. deactivated intake lift 506). The auxiliary valve lift 402 also occurs immediately after the deactivation window 502, therefore no deep vacuum is created within the cylinder 108. The first auxiliary valve lift 402 occurs at a crank angle of about 420 degrees to about 540 degrees.

As shown in FIG. 8, the second auxiliary valve lift 600 occurs during the second deactivated intake stroke 506 which is also during the re-activation window 508. The second auxiliary valve lift 600 occurs at a crank angle of about 1150 degrees to about 1260 degrees.

According to this embodiment, the re-activation window 508 is longer than the deactivation window 502. For example, the re-activation window 508 may be about two and a half times longer than the deactivation window 502. The deactivation window occurs between a crank angle of about 150 degrees to about 330 degrees (e.g., a range of about 180 degrees) while the re-activation window 508 occurs between a crank angle of about 1110 degrees to about 1560 degrees (e.g. a range of about 450 degrees). The combustion cycle 300 of FIG. 8 reactivates the exhaust lift 404 first when returning to a default combustion cycle 300.

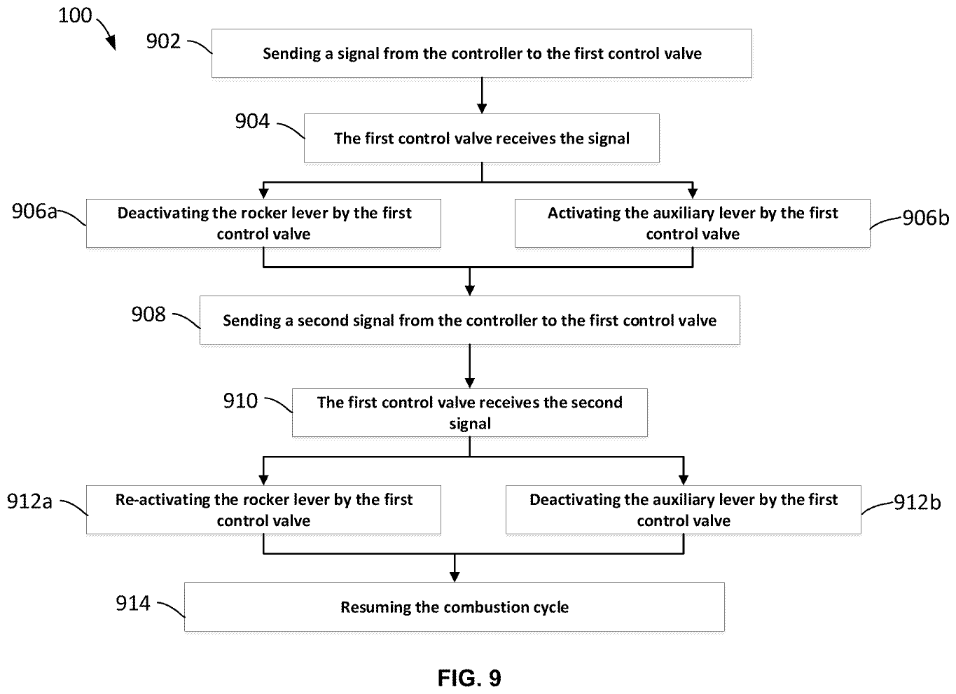

FIG. 9 illustrates an example method of operating the engine system 100 according to one embodiment. The method of FIG. 9 illustrates operating an engine 102 by a controller 104 sending signals to a first control valve 144. According to this embodiment, the engine system 100 only includes a first control valve 144. The method includes receiving a first signal at the first control valve 144. In response to the received first signal, the rocker lever 132 is deactivated by the first control valve 144, thereby deactivating the cylinder 108 by closing the first exhaust valve 124a and the second exhaust valve 124b. Also in response to the received first signal the auxiliary rocker lever 134 is activated by the first control valve 144 to open the second exhaust valve 124b, allowing an amount of exhaust to flow into the cylinder 108 during the rebreathing lift 400. The method further includes receiving a second signal at the first control valve 144. In response to the received second signal, the auxiliary rocker lever 134 is deactivated by the first control valve 144. Also in response to the received second signal, the rocker lever 132 is re-activated by the first control valve 144, thereby re-activating the first cylinder 108 by opening at least one of the first exhaust valve 124a, the second exhaust valve 124b, or the intake valve 120.

The method includes sending the first signal from the controller 104 to the first control valve 144 at 902. The first signal can be sent during the exhaust lift 404. The first signal is then received by the first control valve 144 at 904a. In response to receiving the first signal, the first control valve 144 deactivates the rocker lever 132 at 906a. By deactivating the rocker lever 132, the intake valve 120 and the exhaust valve 124 will remain closed and no fuel will be injected into the cylinder until the rocker lever 132 is re-activated.

At 906b, the first control valve 144 activates the auxiliary rocker lever 134. According to this embodiment, the deactivation of the rocker lever 132 and the activation of the auxiliary rocker lever 134 can occur at the same time (e.g., simultaneously). In other embodiments, the deactivation of the rocker lever 132 and the activation of the auxiliary rocker lever 134 may occur at different timings. The activated auxiliary rocker lever 134 performs a rebreathing lift 400. During the rebreathing lift 400, the auxiliary rocker lever 134 moves at least one exhaust valve 124 a distance (e.g. 2 mm) away from the exhaust port 126 to allow exhaust to flow back into the cylinder 108. The auxiliary rocker lever 134 can perform a plurality of rebreathing lifts 400 while the combustion cycle 300 is deactivated (e.g., when the rocker lever 132 is deactivated).

A second signal is then sent by the controller 104 to the first control valve 144 at 908. The second signal can be sent during the deactivated combustion cycle 300 when the exhaust lift 404 would have occurred. The first control valve 144 receives the second signal at 910.

At 912a, the first control valve 144 re-activates the rocker lever 132. The re-activated rocker lever 132 then resumes a default combustion cycle 300.

At 912b, the first control valve 144 deactivates the auxiliary rocker lever 134. According to this embodiment, the deactivation of the axillary rocker lever 134 and the re-activation of the rocker lever 132 may occur simultaneously. In other embodiments, the deactivation of the auxiliary rocker lever 134 and the activation of the rocker lever 132 may occur at different timings. For example, the auxiliary rocker lever 134 may be deactivated before the rocker lever 132 is re-activated. For example, the second signal can deactivate the auxiliary rocker lever 134 after performing a number (e.g., two) of consecutive rebreathing lifts 400 and then re-activate the rocker lever 132 to resume the default combustion cycle 300 at a later time. The deactivated auxiliary rocker lever 134 remains deactivated, meaning no rebreathing lift 400 occurs, until the controller 104 sends another signal to the first control valve 144 to activate the auxiliary rocker lever 134 again.

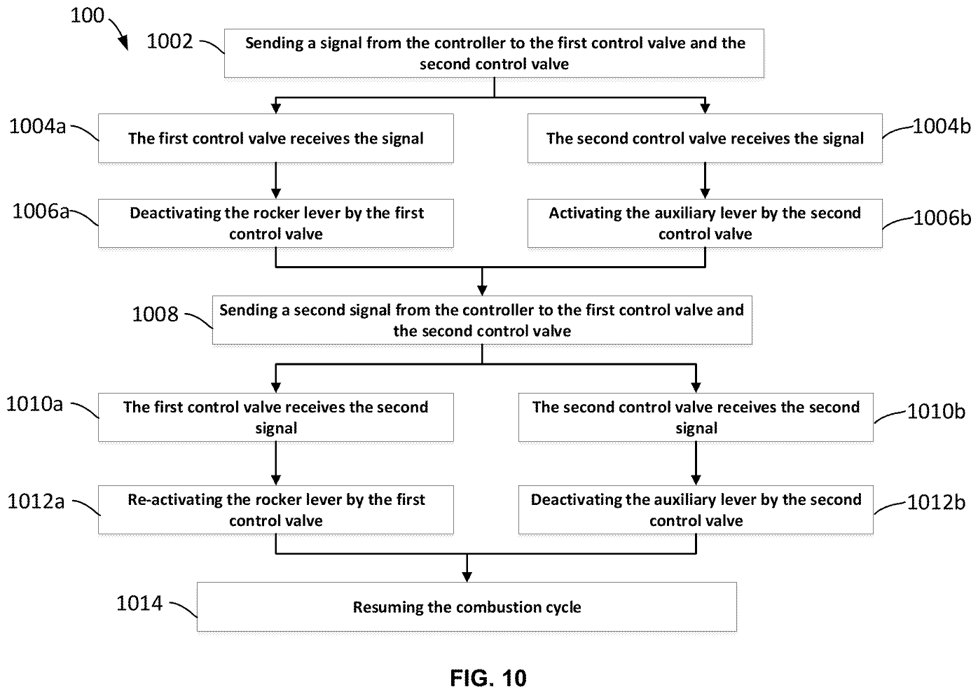

FIG. 10 illustrates an example method of operating the engine system 100 according to another embodiment. The method of FIG. 10 relates to operating an engine 102 according to the combustion cycle 300. The method includes receiving a first signal at the first control valve 144 and the second control valve 146. In response to the received first signal, the rocker lever 132 is deactivated by the first control valve 144, thereby deactivating the cylinder 108 by closing the first exhaust valve 124a and the second exhaust valve 124b. Also in response to the received first signal the auxiliary rocker lever 134 is activated by the second control valve 146 to open the second exhaust valve 124b, allowing an amount of exhaust to flow into the cylinder 108 during the rebreathing lift 400. The method further includes receiving a second signal at the first control valve 144 and the second control valve 146. In response to the received second signal, the auxiliary rocker lever 134 is deactivated by the second control valve 146. Also in response to the received second signal, the rocker lever 132 is re-activated by the first control valve 144, thereby re-activating the first cylinder 108 by opening at least one of the first exhaust valve 124a, the second exhaust valve 124b, or the intake valve 120.

The method includes sending the first signal from the controller 104 to the first control valve 144 and the second control valve 146 at 1002. The first signal can be sent during the exhaust lift 404 of the default combustion cycle 300. The first signal is then received by the first control valve 144 and the second control valve 146 at 1004a and 1004b, respectively. The first control valve 144 and the second control valve 146 may receive the first signal at different timings. For example, the first control valve 144 may receive the first signal and then the second control valve 146 may receive the first signal at a later time. In response to receiving the first signal, the first control valve 144 deactivates the rocker lever 132 at 1006a. By deactivating the rocker lever 132, the intake valve 120 and the exhaust valve 124 will remain closed and no fuel will be injected into the cylinder (e.g., the engine system 100 is in cylinder deactivation (CDA) mode).

At 1006b, the second control valve 146 activates the auxiliary rocker lever 134. The activated auxiliary rocker lever 134 performs a rebreathing lift 400. The activated auxiliary rocker lever 134 may perform a plurality of rebreathing lifts 400. For example, the first signal can control the auxiliary rocker lever 134 to perform a number (e.g., two, three, four, etc.) consecutive rebreathing lifts 400. During the rebreathing lift 400, the auxiliary rocker lever 134 moves at least one exhaust valve 124 a distance (e.g. 2 mm) away from the exhaust port 126 to allow exhaust to flow back into the cylinder 108.

A second signal is then sent by the controller 104 to the first control valve 144 and the second control valve 146 at 1008. The first control valve 144 and the second control valve 146 receive the second signal at 1010a and 1010b, respectively.

At 1012a, the first control valve 144 re-activates the rocker lever 132. The re-activated rocker lever 132 then resumes a default combustion cycle performing the intake stroke 302, the compression stroke 304, the power stroke 306, and the exhaust stroke 308.

At 1012b, the second control valve 146 deactivates the auxiliary rocker lever 134. The deactivated auxiliary rocker lever 134 remains deactivated, meaning no rebreathing lift 400 occurs, until the controller 104 sends another signal to the second control valve 146 to activate the auxiliary rocker lever 134 again. In some embodiments, the first control valve 144 and the second control valve 146 may receive the second signal simultaneously or at about the same time. In other embodiments, the second control valve 146 may receive the second signal before the first control valve 144. For example, the second control valve 146 can receive the second signal first and can then deactivate the auxiliary rocker lever 134 before the first control valve receives the second signal. The first control valve 144 can then receive the second signal and re-activate the rocker lever 132 after the auxiliary rocker lever 134 is already deactivated.

### IV. Construction of Example Embodiments

While this specification contains many specific implementation details, these should not be construed as limitations on the scope of what may be claimed but rather as descriptions of features specific to particular implementations. Certain features described in this specification in the context of separate implementations can also be implemented in combination in a single implementation. Conversely, various features described in the context of a single implementation can also be implemented in multiple implementations separately or in any suitable subcombination. Moreover, although features may be described as acting in certain combinations and even initially claimed as such, one or more features from a claimed combination can, in some cases, be excised from the combination, and the claimed combination may be directed to a subcombination or variation of a subcombination.

As utilized herein, the terms “generally,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the present disclosure.

The term “coupled” and the like, as used herein, mean the joining of two components directly or indirectly to one another. Such joining may be stationary (e.g., permanent) or moveable (e.g., removable or releasable). Such joining may be achieved with the two components or the two components and any additional intermediate components being integrally formed as a single unitary body with one another, with the two components, or with the two components and any additional intermediate components being attached to one another.

It is important to note that the construction and arrangement of the system shown in the various example implementations is illustrative only and not restrictive in character. All changes and modifications that come within the spirit and/or scope of the described implementations are desired to be protected. It should be understood that some features may not be necessary, and implementations lacking the various features may be contemplated as within the scope of the application, the scope being defined by the claims that follow. When the language “a portion” is used, the item can include a portion and/or the entire item unless specifically stated to the contrary.

Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, Z, X and Y, X and Z, Y and Z, or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

Additionally, the use of ranges of values (e.g., W to P, etc.) herein are inclusive of their maximum values and minimum values (e.g., W to P includes W and includes P, etc.), unless otherwise indicated. Furthermore, a range of values (e.g., W to P, etc.) does not necessarily require the inclusion of intermediate values within the range of values (e.g., W to P can include only W and P, etc.), unless otherwise indicated.

1. An engine system comprising:
an engine comprising an engine block, the engine block comprising a plurality of cylinders defining a plurality of combustion chambers and at least one cylinder head, the plurality of combustion chambers each having one of a plurality of pistons positioned therein;
a crankshaft coupled to each of the plurality of pistons, the crankshaft configured to move each of the plurality of pistons from a first piston position to a second piston position;
a camshaft coupled to the crankshaft;
a rocker lever coupled to the camshaft, the rocker lever configured to open and close a first exhaust valve and a second exhaust valve positioned on the at least one cylinder head;
an auxiliary rocker lever coupled to the camshaft, the auxiliary rocker lever configured to open and close the second exhaust valve positioned on the at least one cylinder head at a time when the rocker level would typically open and close the first exhaust valve and the second exhaust valve when the rocker lever is deactivated;
a first control valve coupled to the engine, the first control valve configured to deactivate the rocker lever; and
a controller communicatively coupled to the first control valve, the controller configured to selectively actuate at least the first control valve.

2. The engine system of claim 1, wherein the controller is configured to send a first signal to the first control valve to activate the auxiliary rocker lever.

3. The engine system of claim 2, wherein the first control valve deactivates the rocker lever in response to the first signal sent by the controller.

4. The engine system of claim 1, wherein the rocker lever further comprises a rocker lever roller joint comprising a first roller coupled to a first cam lobe of a plurality of cam lobes, the first roller configured to follow the first cam lobe, moving the rocker lever from a first position to a second position, opening at least the first exhaust valve.

5. The engine system of claim 1, wherein the controller is configured to send a deactivation signal to the first control valve, thereby causing the first control valve to deactivate the auxiliary rocker lever and re-activate the rocker lever.

6. The engine system of claim 5, wherein the auxiliary rocker lever further comprises an auxiliary rocker lever roller joint comprising a second roller coupled to a second cam lobe of the plurality of cam lobes, the second roller joint configured to follow the second cam lobe.

7. The engine system of claim 1, further comprising a second control valve configured to:
selectively activate the auxiliary rocker lever in response to the deactivation of the rocker lever; and
deactivate the auxiliary rocker lever.

8. The engine system of claim 1, further comprising a brake rocker lever coupled to the camshaft, the brake rocker lever configured to operate engine braking.

9. The engine system of claim 8, further comprising:
an actuator coupled to the rocker lever and a crosshead, the actuator configured to selectively engage the crosshead to open both the first exhaust valve and the second exhaust valve;
an auxiliary actuator coupled to the auxiliary rocker lever and extending through the crosshead, the auxiliary actuator configured to selectively open the second exhaust valve when the actuator is disengaged from the crosshead; and
a brake rocker actuator coupled to the brake rocker lever and extending through the crosshead, the brake rocker actuator configured to open the first exhaust valve when the actuator is disengaged from the crosshead and the second exhaust valve is closed.

10. A method of operating an engine according to a combustion cycle, comprising:
receiving a first signal at a first control valve;
in response to the received first signal:
deactivating, by the first control valve, a rocker lever, thereby deactivating a cylinder by closing a first exhaust valve, a second exhaust valve, and an intake valve; and
activating, by the first control valve, an auxiliary rocker lever to open the second exhaust valve, allowing an amount of exhaust to flow into the cylinder during a first rebreathing lift, the rebreathing lift occurring at a time when the rocker level would typically open and close the first exhaust valve and the second exhaust valve;
receiving a second signal at the first control valve;
in response to the received second signal:
deactivating the auxiliary rocker lever; and
re-activating the rocker lever, thereby re-activating the cylinder by opening at least one of the first exhaust valve, the second exhaust valve, or the intake valve.

11. The method of claim 10, wherein deactivating the rocker lever occurs after an exhaust stroke, the exhaust stroke defining a deactivation time period.

12. The method of claim 11, wherein the first rebreathing lift is an exhaust rebreathing lift that occurs during the exhaust stroke after the deactivation time period.

13. The method of claim 11, further comprising opening the intake valve for air to flow into the cylinder during an intake stroke after re-activating the rocker lever defining a re-activation time period.

14. The method of claim 13, wherein the re-activation time period is greater than the deactivation time period such that re-activating the rocker lever comprises opening the first exhaust valve and the second exhaust valve to perform the exhaust stroke and resume the combustion cycle.

15. The method of claim 10, wherein both the intake valve and at least one of the first exhaust valve and the second exhaust valve are open defining a transition time period.

16. The method of claim 10, further comprising:
activating the auxiliary rocker lever to open the second exhaust valve, allowing an amount of exhaust to flow into the cylinder during a second rebreathing lift.

17. The method of claim 16, wherein the first rebreathing lift and the second rebreathing lift are intake rebreathing lifts that occur during an intake lift.

18. The method of claim 10, further comprising:
activating the auxiliary rocker lever to perform engine braking; and
deactivating the auxiliary rocker lever to end exhaust braking.

19. The method of claim 10, further comprising:
activating a brake rocker lever, the brake rocker lever configured to perform exhaust braking; and
deactivating the brake rocker lever to end exhaust braking.

20. A controller, the controller configured to:
send a first signal to a first control valve for an engine, the first signal instructing the first control valve to de-activate a rocker lever, the first signal further instructing the first control valve to activate an auxiliary rocker lever to move from a first auxiliary position to a second auxiliary position opening and closing at least one exhaust valve during a rebreathing lift, the rebreathing lift occurring a time when the rocker level would typically open and close the first exhaust valve and the second exhaust valve; and
send a second signal to the first control valve for the engine, the second signal instructing the first control valve to deactivate the auxiliary rocker lever, the second signal further instructing the first control valve to re-activate the rocker lever to move from a first position to a second position opening and closing at least one exhaust valve.

21. An engine system comprising:
an engine comprising an engine block, the engine block comprising a plurality of cylinders defining a plurality of combustion chambers and at least one cylinder head, the plurality of combustion chambers each having one of a plurality of pistons positioned therein;
a crankshaft coupled to each of the plurality of pistons, the crankshaft configured to move each of the plurality of pistons from a first piston position to a second piston position;
a camshaft coupled to the crankshaft;
a rocker lever coupled to the camshaft, the rocker lever configured to open and close a first exhaust valve and a second exhaust valve positioned on the at least one cylinder head;
an auxiliary rocker lever coupled to the camshaft, the auxiliary rocker lever configured to open and close the second exhaust valve positioned on the at least one cylinder head;
a brake rocker lever coupled to the camshaft, the brake rocker lever configured to operate engine braking;
an actuator coupled to the rocker lever and a crosshead, the actuator configured to selectively engage the crosshead to open both the first exhaust valve and the second exhaust valve;
an auxiliary actuator coupled to the auxiliary rocker lever and extending through the crosshead, the auxiliary actuator configured to selectively open the second exhaust valve when the actuator is disengaged from the crosshead;
a brake rocker actuator coupled to the brake rocker lever and extending through the crosshead, the brake rocker actuator configured to open the first exhaust valve when the actuator is disengaged from the crosshead and the second exhaust valve is closed;
a first control valve coupled to the engine, the first control valve configured to deactivate the rocker lever; and
a controller communicatively coupled to the first control valve, the controller configured to selectively actuate at least the first control valve.

22. A method of operating an engine according to a combustion cycle, comprising:
receiving a first signal at a first control valve;
in response to the received first signal:
deactivating, by the first control valve, a rocker lever, thereby deactivating a cylinder by closing a first exhaust valve, a second exhaust valve, and an intake valve, wherein deactivating the rocker lever occurs after an exhaust stroke, the exhaust stroke defining a deactivation time period; and
activating, by the first control valve, an auxiliary rocker lever to open the second exhaust valve, allowing an amount of exhaust to flow into the cylinder during a first rebreathing lift;
receiving a second signal at the first control valve;
in response to the received second signal:
deactivating the auxiliary rocker lever;
re-activating the rocker lever, thereby re-activating the cylinder by opening at least one of the first exhaust valve, the second exhaust valve, or the intake valve; and
opening the intake valve for air to flow into the cylinder during an intake stroke after re-activating the rocker lever defining a re-activation time period, wherein the re-activation time period is greater than the deactivation time period such that re-activating the rocker lever comprises opening the first exhaust valve and the second exhaust valve to perform the exhaust stroke and resume the combustion cycle.
